(19) United States
(12) Patent Application Publication
(10) Pub. No.: US 2017/0256237 A1
(43) Pub. Date: Sep. 7, 2017

(54) INFORMATION PROCESSING APPARATUS, INFORMATION PROCESSING METHOD, AND INFORMATION PROCESSING PROGRAM

(71) Applicant: NEC Corporation, Tokyo (JP)

(72) Inventors: Tatsushi YASUDA, Tokyo (JP); Masato KITADA, Tokyo (JP)

(73) Assignee: NEC Corporation, Tokyo (JP)

(21) Appl. No.: 15/511,498

(22) PCT Filed: Jun. 16, 2015
(86) PCT No.: PCT/JP2015/067302

§ 371 Date: Mar. 15, 2017

(30) Foreign Application Priority Data
Sep. 16, 2014 (JP) 2014-188310

(51) Int. Cl. G09G 5/14; G09G 5/38; G06F 3/0488

(52) U.S. Cl. CPC G09G 5/14; G06F 3/04883; G09G 5/38; G09G 2354/00; G09G 2340/0464; G09G 2340/0492

(57) ABSTRACT

According to this invention, it is possible to exchange display positions on a multi-screen by a simple intuitive operation. There is provided an information processing apparatus including a display unit that arranges at least two display frames on a screen, and displays information in each display frame, an orientation detector that detects an orientation of the display unit, and a display controller that performs display, if the orientation detector detects that top and bottom of the display unit have been exchanged, by exchanging top and bottom of display in each of the display frames without changing a position of each of the display frames with respect to the display unit and information displayed in each of the display frames.

### TECHNICAL FIELD

The present invention relates to an information processing apparatus, an information processing method, and an information processing program.

### BACKGROUND ART

In the above technical field, patent literature 1 discloses a technique of exchanging the display position of a main image and that of a sub image by dragging a finger from the central portion of the main image to that of the sub image on a display screen divided into two parts (see FIG. 14).

### CITATION LIST

### Patent Literature

Patent literature 1: Japanese Patent Laid-Open No. 2007-257220

### SUMMARY OF THE INVENTION

### Technical Problem

In the technique described in the above literature, however, many operation conditions (for example, five determination conditions) are necessary to associate a one-way drag operation with exchange of display positions so as to be isolated from a simple drag operation, which is not a simple operation for the user.

The present invention enables to provide a technique of solving the above-described problem.

### Solution to Problem

One aspect of the present invention provides an information processing apparatus comprising:

a display unit that arranges at least two display frames on a screen, and displays information in each display frame;

an orientation detector that detects an orientation of the display unit; and

a display controller that performs display, if the orientation detector detects that top and bottom of the display unit have been exchanged, by exchanging top and bottom of display in each of the display frames without changing a position of each of the display frames with respect to the display unit and information displayed in each of the display frames.

Another aspect of the present invention provides an information processing method comprising:

arranging at least two display frames on a screen, and displaying information in each display frame on a display unit;

detecting an orientation of the display unit; and

performing display, if it is detected in the detecting that top and bottom of the display unit have been exchanged, by exchanging top and bottom of display in each of the display frames without changing a position of each of the display frames with respect to the display unit and information displayed in each of the display frames.

Still other aspect of the present invention provides an information processing program for causing a computer to execute a method, comprising:

arranging at least two display frames on a screen, and displaying information in each display frame on a display unit;

detecting an orientation of the display unit; and

performing display, if it is detected in the detecting that top and bottom of the display unit have been exchanged, by exchanging top and bottom of display in each of the display frames without changing a position of each of the display frames with respect to the display unit and information displayed in each of the display frames.

### Advantageous Effects of Invention

According to the present invention, it is possible to exchange display positions on a multi-screen by a simple intuitive operation.

### BRIEF DESCRIPTION OF DRAWINGS

FIG. 1 is a block diagram showing the arrangement of an information processing apparatus according to the first embodiment of the present invention;

FIG. 2A is a view showing an overview of the operation of the screen exchange processing of an information processing apparatus according to the second embodiment of the present invention;

FIG. 2B is a view showing an overview of the operation of the screen exchange processing of the information processing apparatus according to the second embodiment of the present invention;

FIG. 2C is a view showing an overview of the operation of the screen exchange processing of the information processing apparatus according to the second embodiment of the present invention;

FIG. 2D is a view showing an overview of the operation of the screen exchange processing of the information processing apparatus according to the second embodiment of the present invention;

FIG. 2E is a view showing an overview of the operation of the screen exchange processing of the information processing apparatus according to the second embodiment of the present invention;

FIG. 2F is a view showing an overview of the operation of the screen exchange processing of the information processing apparatus according to the second embodiment of the present invention;

FIG. 3 is a block diagram showing the arrangement of the information processing apparatus according to the second embodiment of the present invention;

FIG. 4A is a view showing association tables between the application display screens and display frames of the information processing apparatus according to the second embodiment of the present invention;

FIG. 4B is a view showing association tables between the application display screens and display frames of the information processing apparatus according to the second embodiment of the present invention;

FIG. 5 is a table showing a screen exchange condition determination table of the information processing apparatus according to the second embodiment of the present invention;

FIG. 6 is a block diagram showing the hardware arrangement of the information processing apparatus according to the second embodiment of the present invention;

FIG. 7 is a flowchart illustrating the screen operation processing of the information processing apparatus according to the second embodiment of the present invention;

FIG. 8 is a flowchart illustrating the screen exchange processing of the information processing apparatus according to the second embodiment of the present invention;

FIG. 9 is a view showing an overview of the operation of the screen exchange processing of an information processing apparatus according to the third embodiment of the present invention;

FIG. 10 is a table showing a screen exchange condition determination table of the information processing apparatus according to the third embodiment of the present invention;

FIG. 11 is a flowchart illustrating the screen operation processing of the information processing apparatus according to the third embodiment of the present invention; and

FIG. 12 is a flowchart illustrating the screen exchange processing of the information processing apparatus according to the third embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

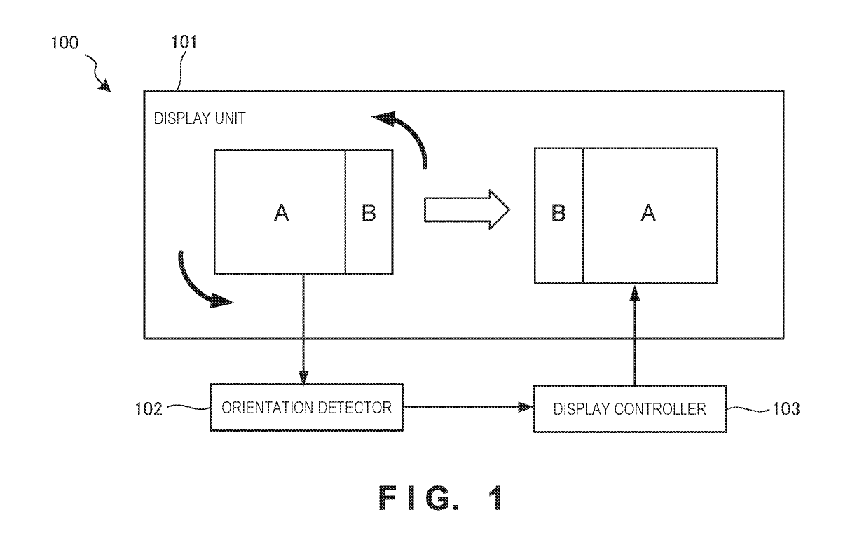

An information processing apparatus 100 according to the first embodiment of the present invention will be described with reference to FIG. 1. The information processing apparatus 100 is an apparatus for exchanging display positions on a multi-screen by exchanging the top and bottom of a display unit.

As shown in FIG. 1, the information processing apparatus 100 includes a display unit 101, an orientation detector 102, and a display controller 103. The information display unit 100 arranges at least two display frames on a screen, and displays information in each display frame. The orientation detector 102 detects the orientation of the display unit 101. If the orientation detector 102 detects that the top and bottom of the display unit 101 have been exchanged, the display controller 103 does not change the position of each display frame with respect to the display unit 101 and the information displayed in each display frame. Then, the display controller 103 performs display by exchanging the top and bottom of the display in each display frame.

According to the present invention, it is possible to exchange display positions on a multi-screen by a simple intuitive operation.

### Second Embodiment

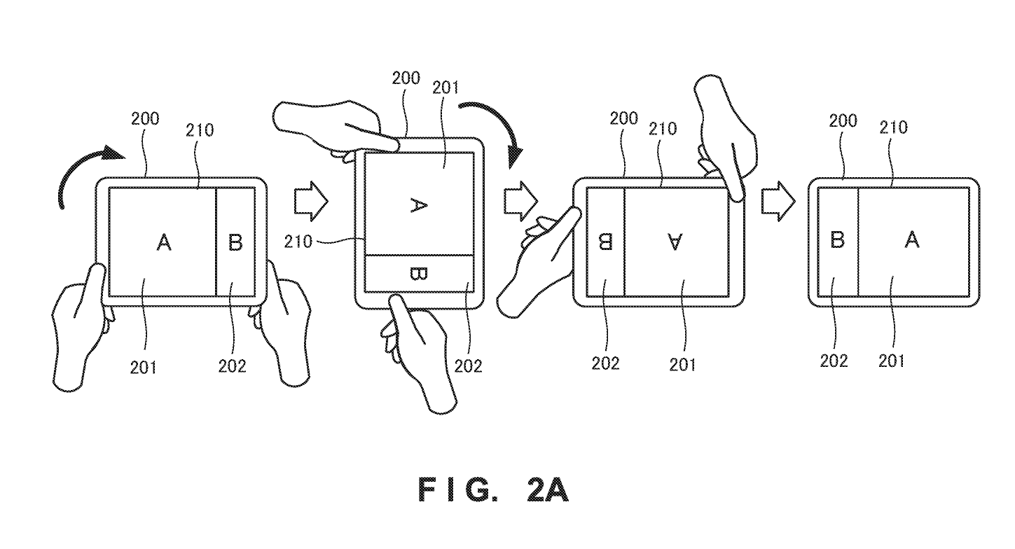

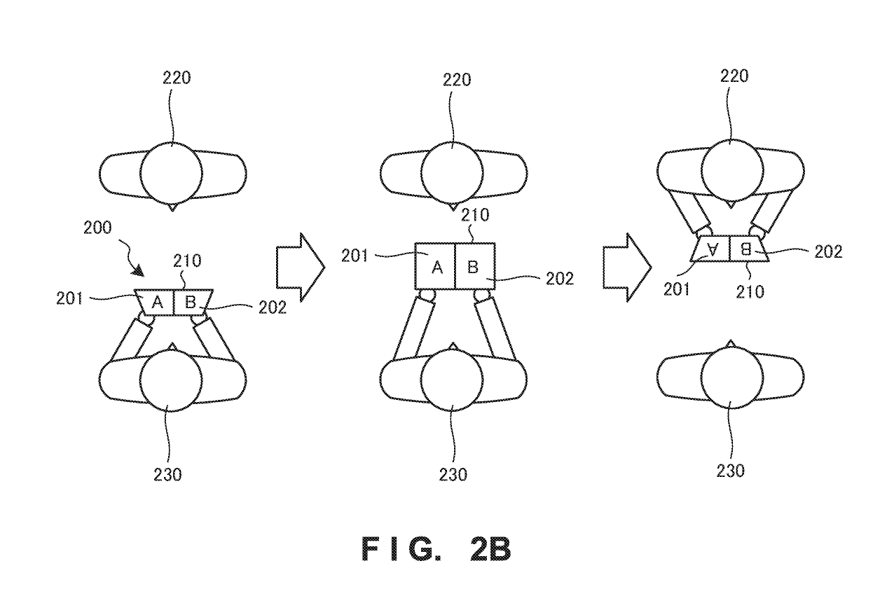

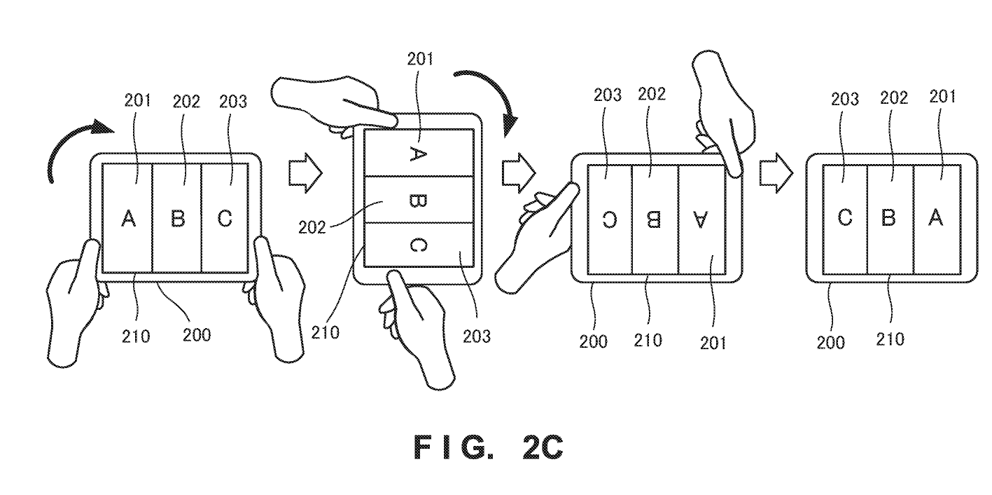

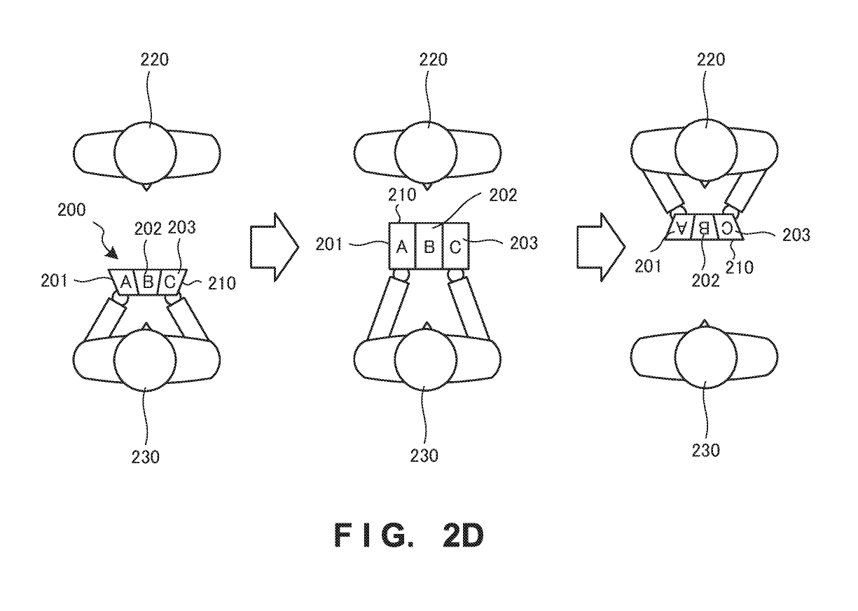

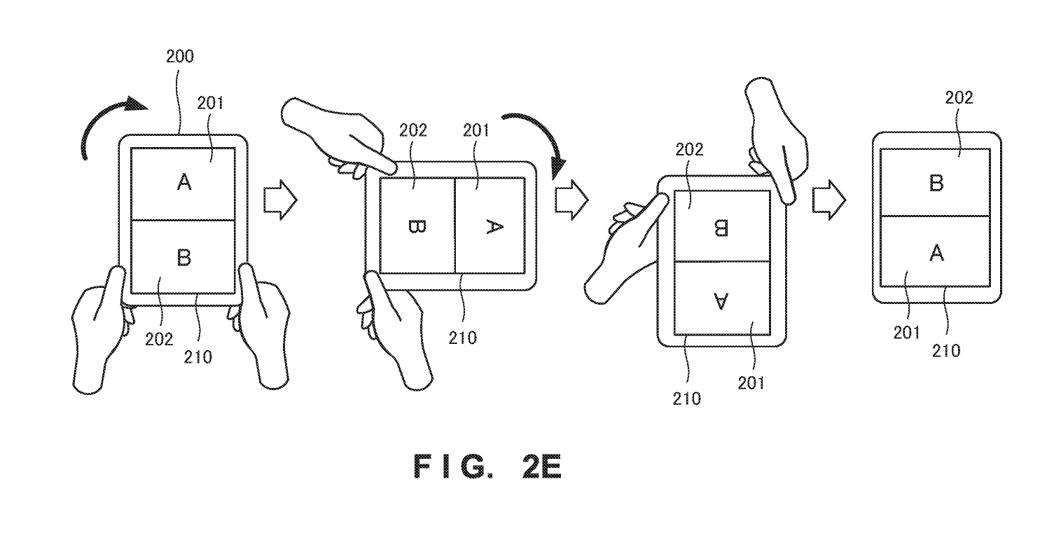

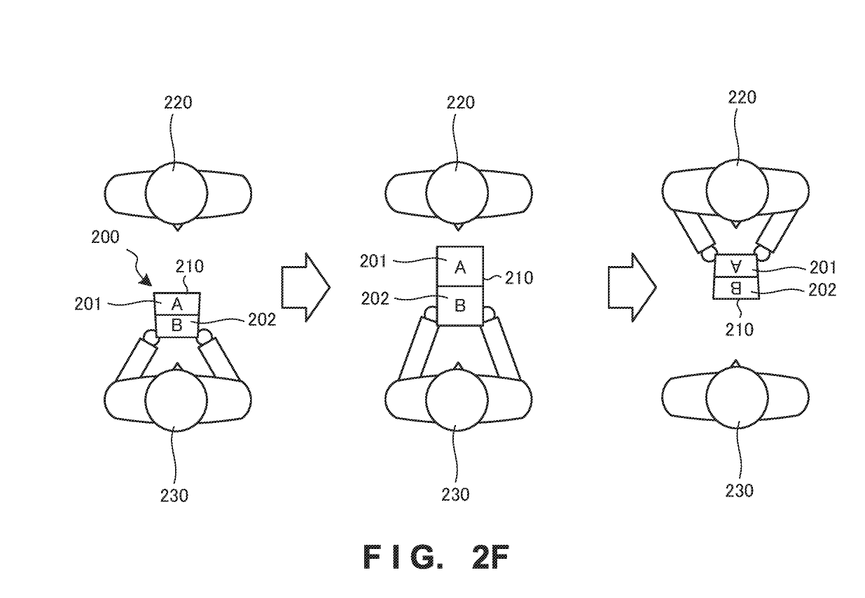

An information processing apparatus 200 according to the second embodiment of the present invention will be described next with reference to FIGS. 2A to 8. FIGS. 2A to 2F are views for explaining an overview of an operation by the information processing apparatus 200 according to this embodiment.

FIG. 2A is a view showing a case in which the right and left display positions on a display screen 210 are exchanged by rotating the information processing apparatus 200 to exchange its top and bottom according to this embodiment. A screen A 201 is displayed on the left side of the display screen 210 of the information processing apparatus 200 in the landscape orientation, and a screen B 202 is displayed on the right side of the display screen 210.

If the user rotates the information processing apparatus 200 in the clockwise direction while holding the outer frame of the information processing apparatus 200, the screens displayed on the display screen 210 of the information processing apparatus 200 transit, as shown in FIG. 2A. That is, in a state in which the information processing apparatus 200 is rotated in the clockwise direction by 90° (the second view from left), the information processing apparatus 200 is set in the portrait orientation. In the portrait orientation, the screen A 201 and screen B 202 are in a landscape display mode, thereby obtaining a state in which the screen A 201 is arranged on the upper side of the display screen 210 and the screen B 202 is arranged on the lower side of the display screen 210.

If, in this state, the information processing apparatus 200 is further rotated in the clockwise direction by 90° (the third view from left), the information processing apparatus 200 is reset in the landscape orientation, and the top and bottom of the information processing apparatus 200 are exchanged. In this state, the screen A 201 and the screen B 202 are in a portrait display mode but the displays of the screen A 201 and screen 202 are upside down.

If, in this state, the top and bottom of the display of each of the screen A 201 and screen B 202 are exchanged (the rightmost view), the right and left screen positions are exchanged. That is, the arrangement position of the screen A 201 and that of the screen B 202 are exchanged. Consequently, the screen B 202 is displayed on the left side of the display screen 210, and the screen A 201 is displayed on the right side of the display screen 210.

FIG. 2B is a view showing a case in which the right and left display positions on the display screen 210 are exchanged when a user 230 presents the information processing apparatus 200 according to this embodiment to a user 220 and thus the top and bottom of the information processing apparatus 200 are exchanged.

When viewed from the user 230, the screen A 201 is displayed on the left side of the display screen 210 of the information processing apparatus 200 and the screen B is displayed on the right side of the display screen 210. The user 230 presents the information processing apparatus 200 to show the user 220 in front of him/her the display screen 210 of the information processing apparatus 200 which the user 230 views. Then, the displays of the screen A 201 and screen B 202 are upside down for the user 220. When the user 220 receives the information processing apparatus 200, the top and bottom of the information processing apparatus 200 are exchanged.

If, in this state, the top and bottom of the display of each of the screen A 201 and screen B 202 are exchanged, the right and left arrangements on the display screen 210 when viewed from the user 220 are opposite to those when viewed from the user 230. That is, the right and left positions of the screen A 201 and screen B 202 are exchanged.

However, the right and left arrangements on the display screen 210 when viewed from the user 230 remain unchanged in which the screen A 201 is displayed on the left side and the screen B 202 is displayed on the right side although the displays are upside down. This can be applied to, for example, a case in which even if the user 230 presents the information processing apparatus 200 to the partner user 220, he/she does not want the right and left horizontal arrangements on the display screen 210 to be exchanged.

FIG. 2C is a view showing a case in which the right and left arrangements on the display screen 210 are exchanged by rotating the information processing apparatus 200 according to this embodiment to exchange its top and bottom. While FIG. 2A shows a case of 2-screen display, FIG. 2C shows a case of 3-screen display.

The screens A 201, the screen B 202, and a screen C 203 are sequentially displayed from left on the display screen 210 of the information processing apparatus 200 in the landscape orientation. If the user rotates the information processing apparatus 200 in the clockwise direction while holding the outer frame of the information processing apparatus 200, the screens displayed on the display screen 210 of the information processing apparatus 200 transit, as shown in FIG. 2C. That is, if the information processing apparatus 200 is rotated in the clockwise direction by 90° (the second view from left), the information processing apparatus 200 is set in the portrait orientation. In the portrait orientation, the screen A 201, screen B 202, and screen C 203 are in the landscape display mode, thereby obtaining a state in which the screen A 201, screen B 202, and screen C 203 are sequentially arranged from the upper side of the display screen 210.

If, in this state, the information processing apparatus 200 is further rotated in the clockwise direction by 90° (the third view from left), the information processing apparatus 200 is reset in the landscape orientation, and the top and bottom of the information processing apparatus 200 are exchanged. In this state, the screen A 201, screen B 202, and screen C 203 are in the portrait display mode but the displays of the screen A 201, screen B 202, and screen C 203 are upside down. If, in this state, the top and bottom of the display of each of the screen A 201, screen B 202, and screen C 203 are exchanged (the rightmost view), the screen positions can be exchanged.

That is, the arrangement position of the leftmost screen A 201 and that of the rightmost screen C 203 are exchanged, and the arrangement position of the screen B 202 remains unchanged. This changes the state in which the screen A 201, screen B 202, and screen C 203 are displayed from left in the order named to the state in which the screen C 203, screen B 202, and screen A 201 are displayed from left in the order names, and thus the arrangement positions of the screens are exchanged.

FIG. 2D is a view showing a case in which the arrangements on the display screen 210 are exchanged when the user 230 presents the information processing apparatus 200 according to this embodiment to the user 220 and then the top and bottom of the information processing apparatus 200 are exchanged. While FIG. 2B shows a case of 2-screen display, FIG. 2D shows a case of 3-screen display.

When viewed from the user 230, the screens A 201, screen B 202, and screen C 203 are sequentially displayed from left on the display screen 210 of the information processing apparatus 200. The user 230 presents the information processing apparatus 200 to show the user 220 in front of him/her the display screen 210 of the information processing apparatus 200 which the user 230 views. Then, the displays of the screen A 201, screen B 202, and screen C 203 are upside down for the user 220. When the user 220 receives the information processing apparatus 200, the top and bottom of the information processing apparatus 200 are exchanged.

If, in this state, the top and bottom of the display of each of the screen A 201, screen B 202, and screen C 203 are exchanged, the arrangements on the display screen 210 when viewed from the user 220 are opposite to those when viewed from the user 230. That is, the positions of the screen A 201 and screen C 203 are exchanged, and the screen C 203, screen B 202, and screen A 201 are displayed from left in the order named when viewed from the user 220. However, the arrangements on the display screen 210 when viewed from the user 230 remain unchanged in which the screen A 201, screen B 202, and screen C 203 are arranged from left in the order named although the displays are upside down.

This can be applied to, for example, a case in which even if the user 230 presents the information processing apparatus 200 to the partner user 220, he/she does not want the arrangements on the display screen 210 to be exchanged.

FIG. 2E is a view showing a case in which the upper and lower display positions on the display screen 210 are exchanged by rotating the information processing apparatus 200 according to this embodiment to exchange its top and bottom. The screen A 201 is displayed on the upper side of the display screen 210 of the information processing apparatus 200 in the portrait orientation, and the screen B 202 is displayed on the lower side of the display screen 210.

If the user rotates the information processing apparatus 200 in the clockwise direction while holding the outer frame of the information processing apparatus 200, the screens displayed on the display screen 210 of the information processing apparatus 200 transit, as shown in FIG. 2E. That is, in a state in which the information processing apparatus 200 is rotated in the clockwise direction by 90° (the second view from left), the information processing apparatus 200 is set in the landscape orientation. In the landscape orientation, the screen A 201 and screen B 202 are in the landscape display mode, thereby obtaining a state in which the screen A 201 is arranged on the right side of the display screen 210 and the screen B 202 is arranged on the left side of the display screen 210.

If, in this state, the information processing apparatus 200 is further rotated in the clockwise direction by 90° (the third view from left), the information processing apparatus 200 is reset in the portrait orientation, and the top and bottom of the information processing apparatus 200 are exchanged. In this state, the screen A 201 and screen B 202 are in the portrait display mode but the displays of the screen A 201 and screen B 202 are upside down.

If, in this state, the top and bottom of the display of each of the screen A 201 and screen B 202 are exchanged (the rightmost view), the screen positions can be exchanged. That is, the arrangement position of the screen A 201 and that of the screen B 202 are exchanged. Consequently, the screen B 202 is displayed on the upper side of the display screen 210, and the screen A 201 is displayed on the lower side of the display screen 210.

FIG. 2F is a view showing a case in which the upper and lower display positions on the display screen 210 are exchanged when the user 230 presents the information processing apparatus 200 according to this embodiment to the user 220 and thus the top and bottom of the information processing apparatus 200 are exchanged. When viewed from the user 230, the screen A 201 is displayed on the upper side of the display screen 210 of the information processing apparatus 200 and the screen B 202 is displayed on the lower side of the display screen 210.

The user 230 presents the information processing apparatus 200 to show the user 220 in front of him/her the display screen 210 of the information processing apparatus 200 which the user 230 views. Then, the displays of the screen A 201 and screen B 202 are upside down for the user 220. When the user 220 receives the information processing apparatus 200, the top and bottom of the information processing apparatus 200 are exchanged.

If, in this state, the top and bottom of the display of each of the screen A 201 and screen B 202 are exchanged, the arrangements on the display screen 210 when viewed from the user 220 are opposite to those when viewed from the user 230. That is, the upper and lower positions of the screen A 201 and screen B 202 are exchanged, and the screen A 201 is displayed on the upper side and the screen B 202 is displayed on the lower side when viewed from the user 220.

However, the upper and lower arrangements on the display screen 210 when viewed from the user 230 remain unchanged in which the screen B 202 is arranged on the upper side (on the near side when viewed from the user 230) and the screen A 201 is arranged on the lower side (on the far side when viewed from the user 230) although the displays are upside down. This can be applied to, for example, a case in which even if the user 230 presents the information processing apparatus 200 to the partner user 220, he/she does not want the upper and lower arrangements on the display screen 210 to be exchanged.

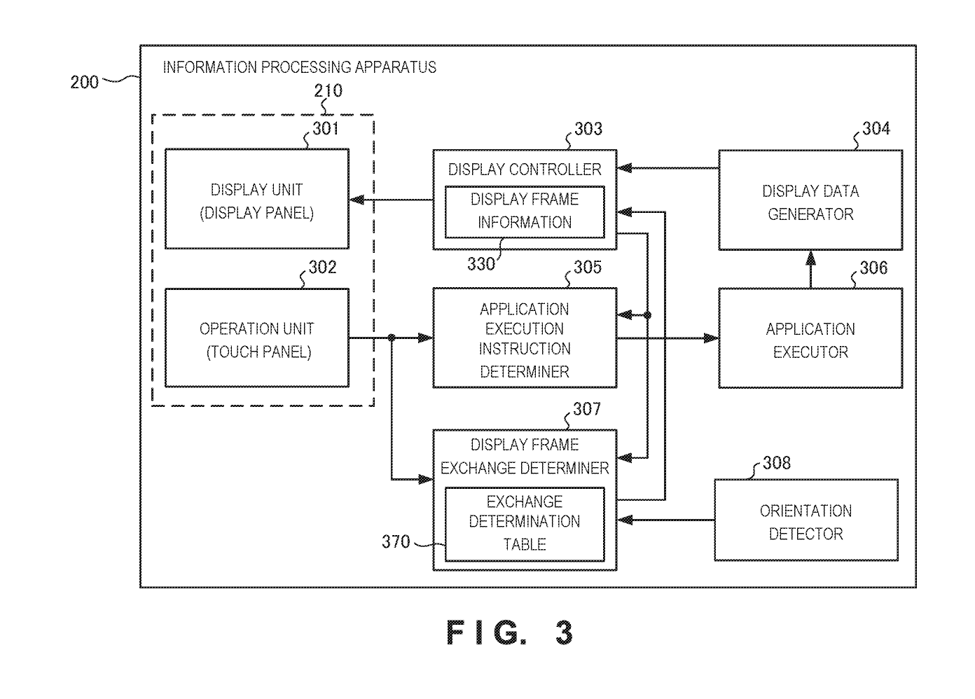

FIG. 3 is a block diagram showing the functional arrangement of the information processing apparatus 200 according to this embodiment. The information processing apparatus 200 includes a display screen formed by a display unit 301 with a display panel and an operation unit 302 with a touch panel. The information processing apparatus 200 also includes a display controller 303, a display data generator 304, an application execution instruction determiner 305, an application executor 306, a display frame exchange determiner 307, and an orientation detector 308.

The application execution instruction determiner 305 determines an application execution instruction in the operation unit 302. In the case of the application execution instruction, the application executor 306 activates an application, and executes it. The display data generator 304 generates display data according to the executed application. The display controller 303 has display frame information 330, assigns, to a display frame, the display data generated by executing the application, and displays the display data on the display unit 301.

The display frame exchange determiner 307 has an exchange determination table 370, and determines exchange of the top and bottom of the display in each display frame based on a change in orientation in the orientation detector 308, that is, based on exchange of the top and bottom of the display screen 210. The display controller 303 exchanges the top and bottom of the display in each display frame, and displays the display frame on the display unit 301. This can exchange the right and left display positions of the screens on the display screen 210 by only exchanging the top and bottom of the display screen 210.

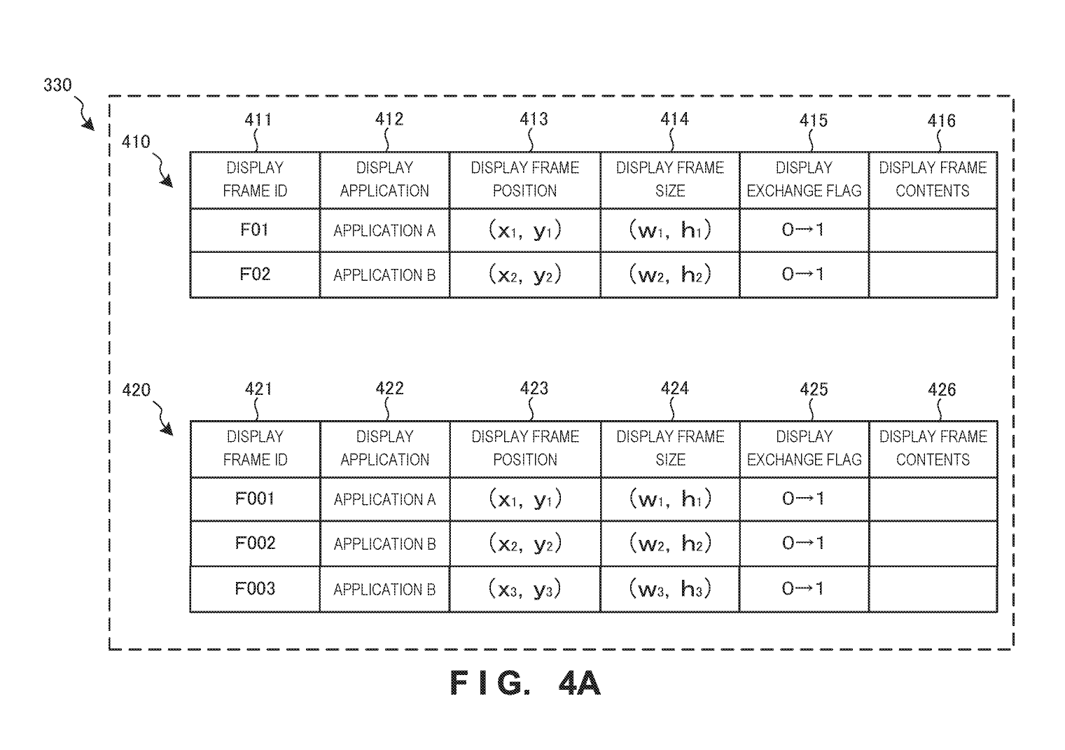

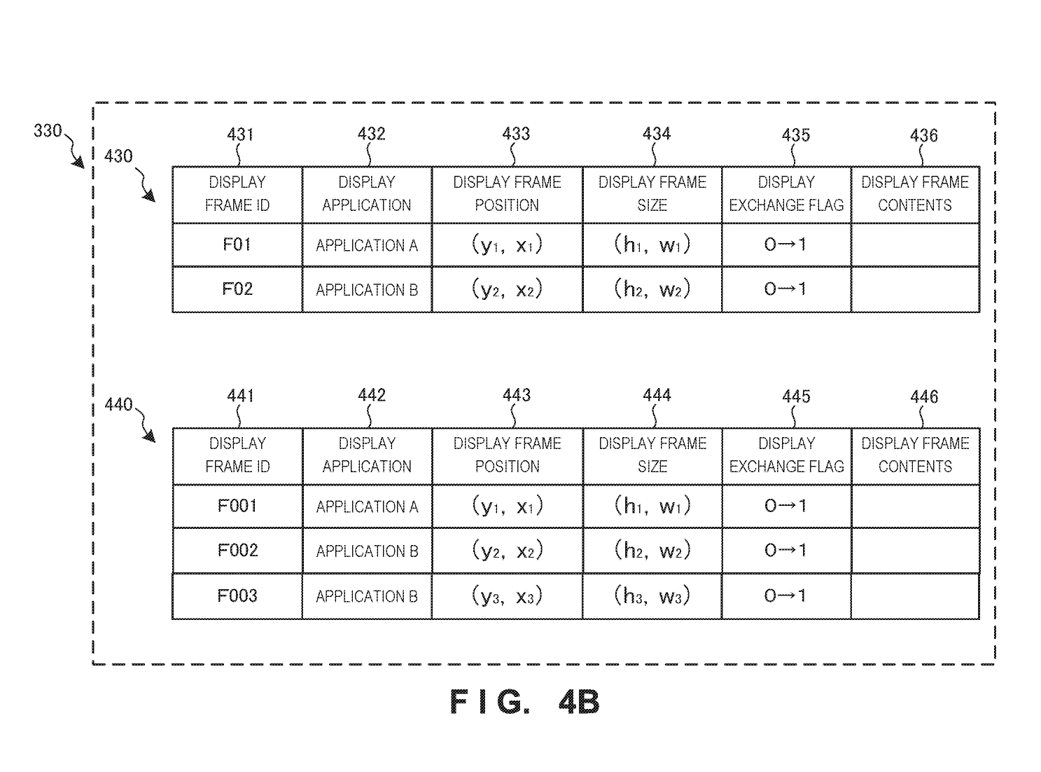

FIGS. 4A and 4B are views each showing the structure of the display frame information 330 according to this embodiment. FIG. 4A shows a case in which the information processing apparatus 200 is in the landscape orientation, and FIG. 4B shows a case in which the information processing apparatus 200 is in the portrait orientation. Among the pieces of display frame information 330, pieces of display frame information 410 and 420 each show an example of 2-screen display, and display information frames 430 and 440 each show an example of 3-screen display.

The display frame information 330 is used by the display controller 303 to arrange display information related to the application on the screen. The display frame information 330 stores a display frame position 413, 423, 433, or 443 and a display frame size 414, 424, 434, or 444 of each frame in association with a display frame ID 411, 421, 431, or 441. The display frame information 330 stores, in association with the display frame ID 411, 421, 431, or 441, as a display application 412, 422, 432, or 442, an application for generating information to be displayed on the display frame. Display frame contents 416, 426, 436, or 446 generated by the application are stored. The display controller 303 exchanges the top and bottom of the display in each frame based on a display exchange flag 415, 425, 435, or 445. If the display exchange flag 415, 425, 435, or 445 is “1”, the top and bottom of the display are exchanged. On the other hand, if the display exchange flag 415, 425, 435, or 445 is “0”, the top and bottom of the display are not exchanged.

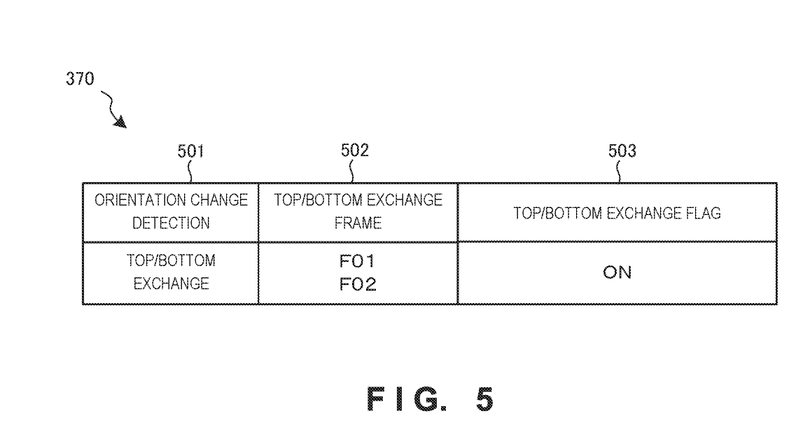

FIG. 5 is a table showing the structure of the exchange determination table 370 according to this embodiment. The exchange determination table 370 is used to determine exchange of the top and bottom of the display in each display frame. Orientation change detection 501, a top/bottom exchange frame 502, and a top/bottom exchange flag 503 are stored in association with each other. If the orientation change detection indicates top/bottom exchange, the display frame exchange determiner 307 decides a frame as the target of exchange of the top and bottom of the display in the display frame based on “ON” or “OFF” of the top/bottom exchange flag 503 of the exchange determination table 370.

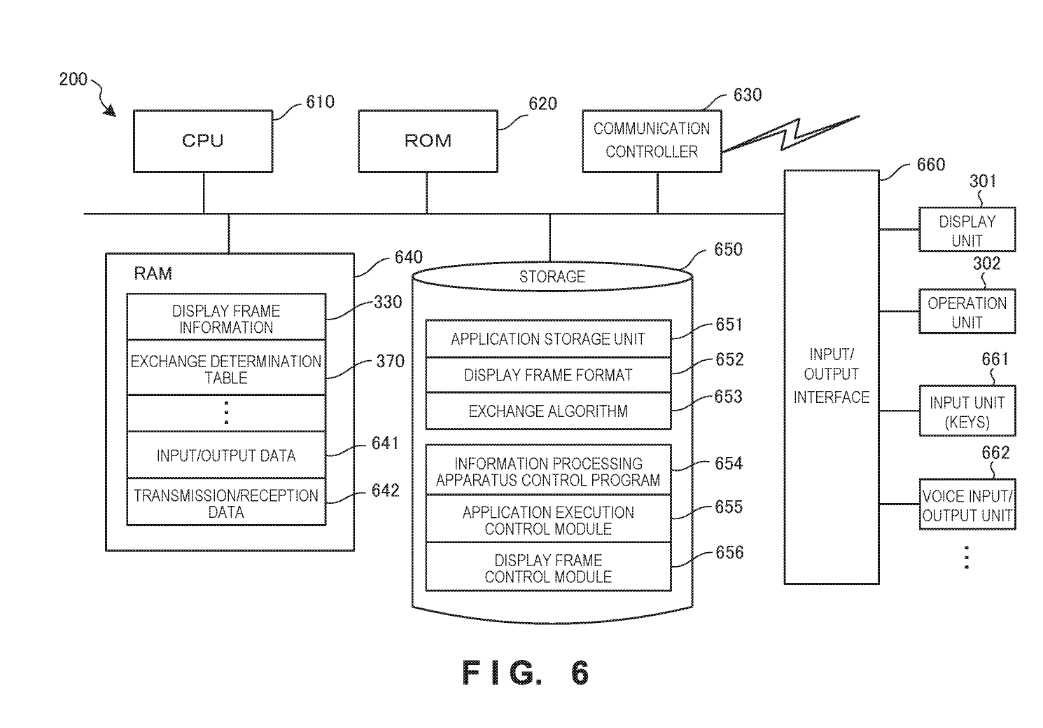

FIG. 6 is a block diagram showing the hardware arrangement of the information processing apparatus 200 according to this embodiment. The information processing apparatus 200 includes a CPU (Central Processing Unit) 610, a ROM (Read Only Memory) 620, and a RAM (Random Access Memory) 640. Furthermore, the information processing apparatus 200 also includes a storage 650, a communication controller 630, and an input/output interface 660.

The CPU 610 is an arithmetic processing processor, and implements the functional components of the information processing apparatus 200 by executing a program. Note that the number of CPUs 610 is not limited to one, and a plurality of CPUs or a GPU (Graphics Processing Unit) for image processing may be included. The ROM 620 is a read only memory, and stores programs such as firmware. The communication controller 630 communicates with another apparatus via a network. The communication controller 630 may include a CPU independent of the CPU 610, and writes or reads out transmission/reception data in or from the RAM 640. Furthermore, the input/output interface 660 may include a CPU independent of the CPU 610, and writes or reads out input/output data in or from the RAM 640.

The RAM 640 is a random access memory used as a temporary storage work area by the CPU 610. An area to store data necessary for implementation of the embodiment is allocated to the RAM 640. The RAM 640 stores, as the data, the display frame information 330, the exchange determination table 370, input/output data 641, transmission/reception data 642, and the like. The display frame information 330 stores the definition of a display frame and the relation with an application. The exchange determination table 370 is used to determine exchange of the top and bottom of the display in each display frame. The input/output data 641 are data transferred to/from the display unit 301 and the operation unit 302 via the input/output interface 660. The transmission/reception data 642 are data transmitted/received via the communication controller 630.

The storage 650 is a storage device that stores a database and programs necessary for implementation of the embodiment. The storage 650 stores an application storage unit 651, a display frame format 652, and an exchange algorithm 653. The storage 650 also stores an information processing apparatus control program 654, an application execution control module 655, and a display frame control module 656.

The information processing apparatus control program 654 is a program for controlling the overall operation of the information processing apparatus 200. The application execution control module 655 is a module for executing applications stored in the application storage unit 651. The display frame control module 656 is a module for controlling the arrangement, on the display unit 301, of the display frames assigned with pieces of display information generated by executing the applications.

The input/output interface 660 serves as an interface for exchanging input/output data with an input/output device or the like. The input/output interface 660 is connected to the display unit 301, the operation unit 302, an input unit 661 with hardware keys, a voice input/output unit 662, and the like. Note that programs and data which are associated with the general-purpose functions of the information processing apparatus 200 and other feasible functions are not shown in the RAM 640 or the storage 650 of FIG. 6.

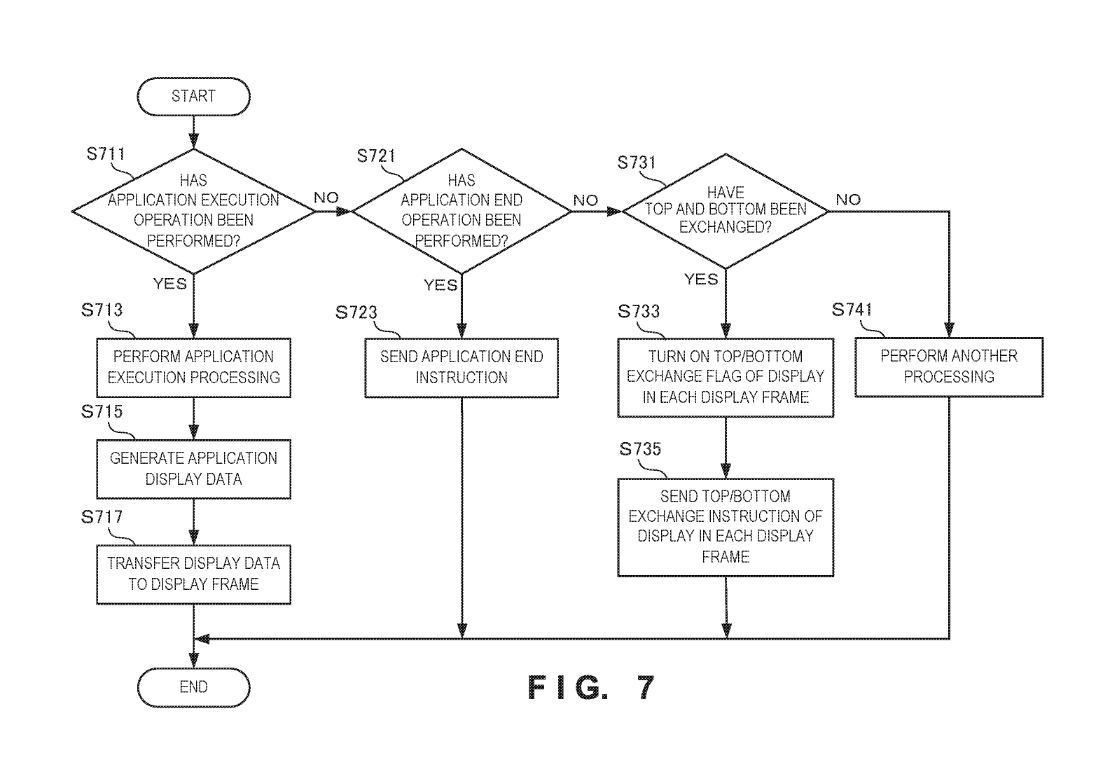

FIG. 7 is a flowchart illustrating the screen operation processing procedure of the information processing apparatus 200 according to this embodiment. This flowchart is executed by the CPU 610 using the RAM 640, thereby implementing the functional components of the information processing apparatus 200.

In step S711, the information processing apparatus 200 determines whether an application execution operation has been performed on the display screen. If an application execution operation has been performed, the information processing apparatus 200 executes an instructed application in step S713. In step S715, the information processing apparatus 200 generates display data related to execution of the application. In step S717, the information processing apparatus 200 transfers the generated display data to a display frame to display it in an assigned display frame.

If no application execution operation has been performed, the information processing apparatus 200 determines in step S721 whether an operation of ending the currently executed application has been performed. If the operation of ending the currently executed application has been performed, the information processing apparatus 200 ends the instructed application in step S723.

If neither an application execution operation nor an application end operation has been performed, the information processing apparatus 200 determines in step S731 whether the top and bottom of the display screen 210 have been exchanged. If the top and bottom have been exchanged, the information processing apparatus 200 turns on the top/bottom exchange flag of the display in each display frame in step S733. In step S735, the information processing apparatus 200 instructs exchange of the top and bottom of the display in each display frame.

If none of an application execution operation, an application end operation, and exchange of the top and bottom has been performed, the information processing apparatus 200 executes, in step S741, another processing instructed and operated.

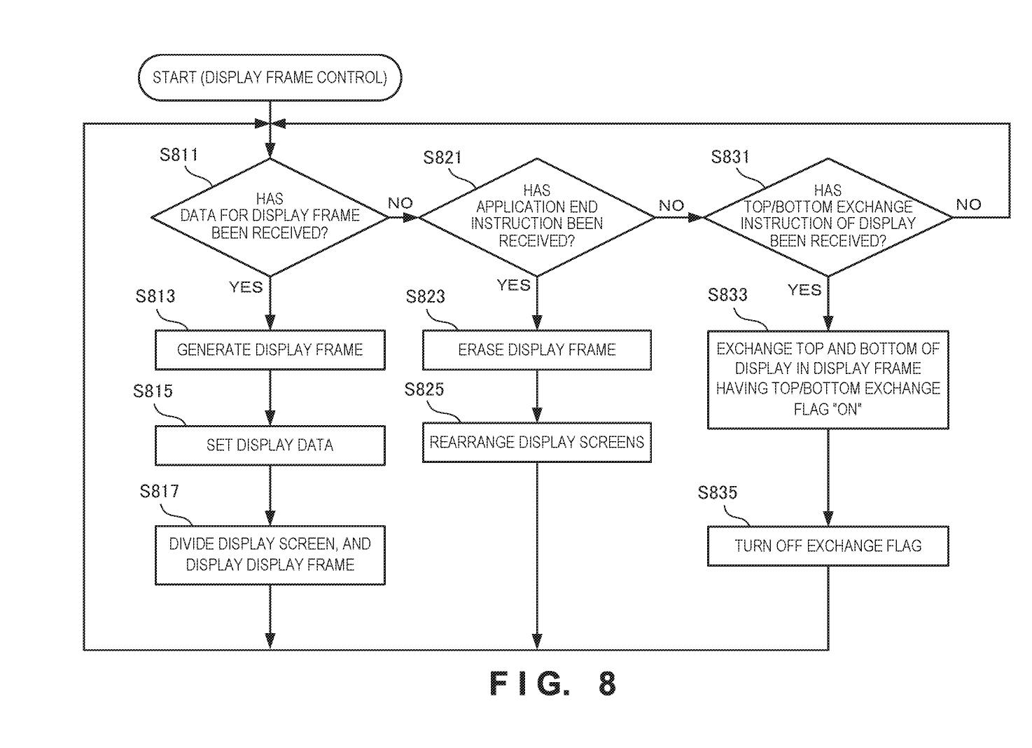

FIG. 8 is a flowchart illustrating the screen exchange processing procedure of the information processing apparatus 200 according to this embodiment. In step S811, the information processing apparatus 200 determines whether data for a display frame has been received by the processing in step S717 of FIG. 7. If data for a display frame has been received, the information processing apparatus 200 generates a display frame in step S813.

Next, in step S815, the information processing apparatus 200 sets the received display data in the generated display frame. In step S817, the information processing apparatus 200 divides the display screen, and displays the display data of the display frame. Note that the procedure of dividing the display screen has been explained in steps S813 to S817 above. If divided screens are generated by a plurality of display frames, the display data is assigned to a display frame in correspondence with the application, and generation of a display frame in step S813 is unnecessary.

If no data for a display frame has been received, the information processing apparatus 200 determines in step S821 whether an application end instruction has been received by the processing in step S723 of FIG. 7. If the application end instruction has been received, the information processing apparatus 200 erases, in step S823, the display frame in which the display data is displayed. In step S825, the information processing apparatus 200 rearranges the display screens. Note that if the divided screens are preset, as described above, data are rearranged in the opened display frames, and erase of the display frame in step S823 is unnecessary.

If neither data for a display frame nor an application end instruction has been received, the information processing apparatus 200 determines in step S831 whether a top/bottom exchange instruction of the display in each display frame has been received by the processing in step S735 of FIG. 7. If the top/bottom exchange instruction has been received, the information processing apparatus 200 exchanges, in step S833, the top and bottom of the display in each display frame having the top/bottom exchange flag “ON”. In step S835, the information processing apparatus 200 turns off the exchange flag.

According to this embodiment, it is possible to readily exchange positions on a multi-screen by only exchanging the top and bottom of the display unit.

### Third Embodiment

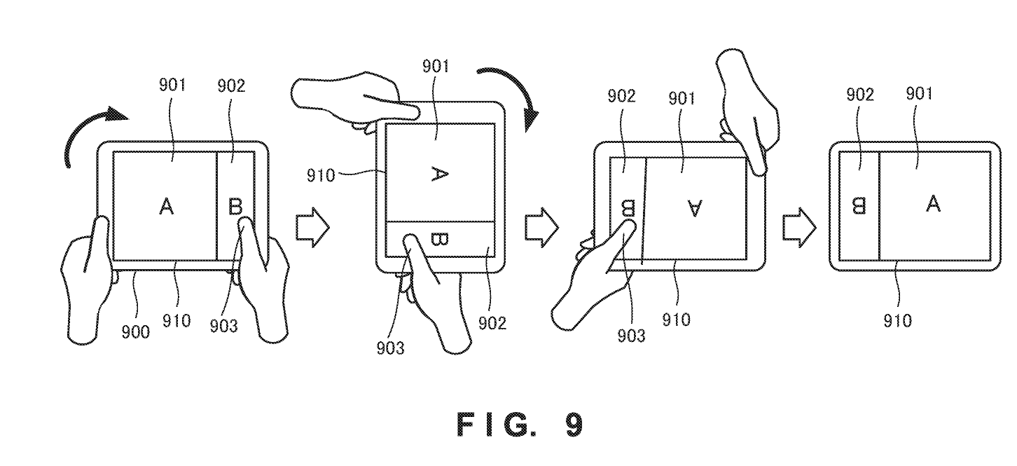

An information processing apparatus 900 according to the third embodiment of the present invention will be described next with reference to FIGS. 9 to 12. FIG. 9 is a view for explaining the operation of the screen exchange processing of the information processing apparatus 900 according to this embodiment. The information processing apparatus 900 according to this embodiment is different from that according to the second embodiment in that the top and bottom of the display of a display frame on which no long touch is currently performed are exchanged without exchanging the top and bottom of the display of a display frame on which a long touch is currently performed. The remaining components and operations are the same as those in the second embodiment. Hence, the same reference numerals denote the same components and operations, and a detailed description thereof will be omitted.

FIG. 9 is a view showing a case in which the right and left display positions on a display screen 910 are exchanged by rotating the information processing apparatus 900 according to this embodiment to exchange its top and bottom but the top and bottom of display in a display frame on which a long touch is currently performed are not exchanged.

A screen A 901 is displayed on the left side of the display screen 910 of the information processing apparatus 900 in the landscape orientation, and a screen B 902 is displayed on the right side of the display screen 910. The user touches the screen B 902 with a finger 903. If, in this state, the user rotates the information processing apparatus 900 in the clockwise direction, the screens displayed on the display screen 910 of the information processing apparatus 900 transit, as shown in FIG. 9.

That is, in a state in which the information processing apparatus 900 is rotated in the clockwise direction by 90° (the second view from left), the information processing apparatus 900 is set in the portrait orientation. In the portrait orientation, the screen A 901 and screen B 902 are in a landscape display mode, thereby obtaining a state in which the screen A 901 is arranged on the upper side of the display screen 910 and the screen B 902 is arranged on the lower side of the display screen 910. If, in this state, the information processing apparatus 900 is further rotated in the clockwise direction by 90° (the third view from left), the information processing apparatus 900 is reset in the landscape orientation, and the top and bottom of the information processing apparatus 900 are exchanged.

In this state, the screen A 901 and the screen B 902 are in a portrait display mode but the displays of the screen A 901 and screen B 902 are upside down. The screen B 902 remains touched with the finger 903 of the user. If the top and bottom of the display of the screen A 901 which is not pressed by the finger 903 are exchanged without exchanging the top and bottom of the display of the screen B 902 which is currently pressed by the finger 903 (the rightmost view), the screen positions are exchanged.

That is, the arrangement position of the screen A 901 and that of the screen B 902 are horizontally exchanged. Consequently, the screen B 902 is displayed on the left side of the display screen 910, and the screen A 901 is displayed on the right side of the display screen 910. However, while the top and bottom of the display of the screen A 901 are normal, the display of the screen B 902 remains upside down.

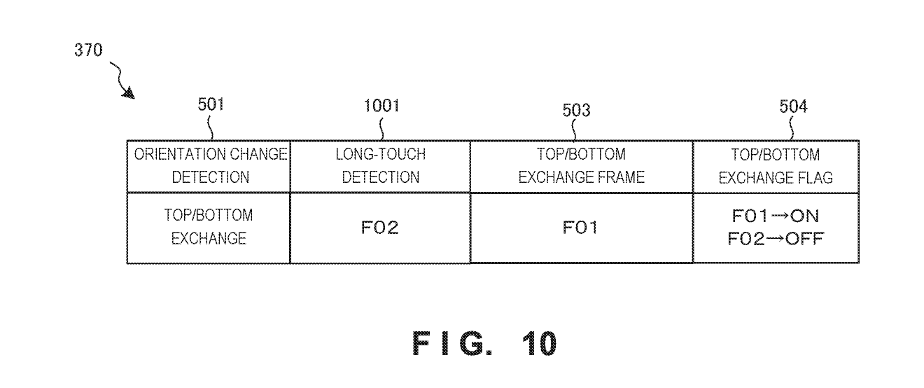

FIG. 10 is a table showing the structure of an exchange determination table 370 according to this embodiment. The exchange determination table 370 is used to determine exchange of the top and bottom of the display in each display frame. The exchange determination table 370 stores orientation change detection 501, long-touch detection 1002, a top/bottom exchange frame 503, and a top/bottom exchange flag 504 in association with each other. If the orientation change detection indicates top/bottom exchange, a display frame exchange determiner 307 decides a frame as the target of exchange of the top and bottom of the display in the display frame based on the exchange determination table 370.

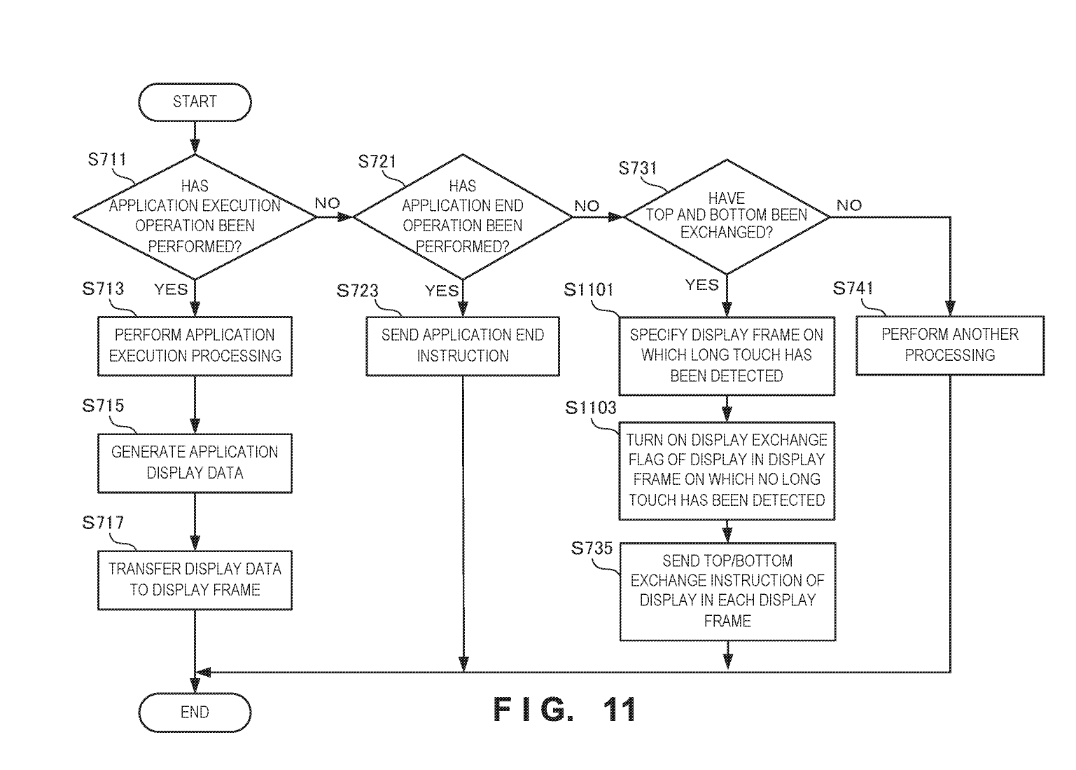

FIG. 11 is a flowchart illustrating the screen operation processing procedure of the information processing apparatus 900 according to this embodiment. Note that the same step numbers as those in FIG. 7 denote the same steps, and a description thereof will be omitted. In step S1101, the information processing apparatus 900 specifies a display frame on which a long touch has been detected. In step S1103, the information processing apparatus 900 turns on a display exchange flag 415, 425, 435, or 445 of a display frame on which no long touch has been detected.

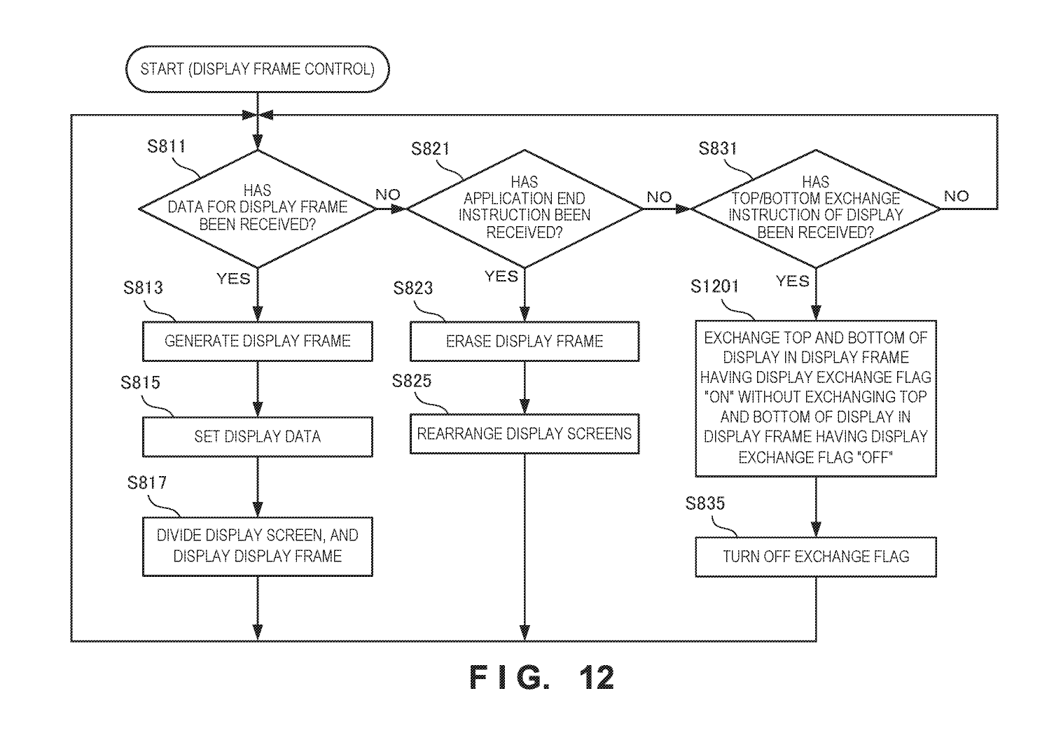

FIG. 12 is a flowchart illustrating the screen exchange processing procedure of the information processing apparatus 900 according to this embodiment. Note that the same step numbers as those in FIG. 8 denote the same steps, and a description thereof will be omitted. If neither data for a display frame nor an application end instruction has been received, the information processing apparatus 900 exchanges, in step S 1201, the top and bottom of the display in the display frame having the display exchange flag “ON”. The top and bottom of the display in the display frame having the display exchange flag “OFF” are not exchanged.

According to this embodiment, since the top and bottom of display in a display frame on which a long touch has been performed are not exchanged, it is possible to exchange display positions on a multi-screen, and maintain display in a display frame in which it is desirable not to exchange the top and bottom of the display, without exchanging the top and bottom.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is applicable to a system including a plurality of devices or a single apparatus. The present invention is also applicable even when an information processing program for implementing the functions of the embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described embodiments.

This application claims the benefit of Japanese Patent Application No. 2014-188310 filed on Sep. 16, 2014, which is hereby incorporated by reference herein in its entirety.

1. An information processing apparatus comprising:
a display unit that arranges at least two display frames on a screen, and displays information in each display frame;
an orientation detector that detects an orientation of said display unit; and
a display controller that performs display, if said orientation detector detects that top and bottom of said display unit have been exchanged, by exchanging top and bottom of display in each of the display frames without changing a position of each of the display frames with respect to said display unit and information displayed in each of the display frames.

2. The information processing apparatus according to claim 21, wherein
said display unit includes a touch panel, and
even if said orientation detector detects that the top and bottom of said display unit have been exchanged, said display controller does not exchange the top and bottom of the display in the display frame, among the at least two display frames, on which a long touch has been detected.

3. An information processing method comprising:
arranging at least two display frames on a screen, and displaying information in each display frame on a display unit;
detecting an orientation of the display unit; and
performing display, if it is detected in the detecting that top and bottom of the display unit have been exchanged, by exchanging top and bottom of display in each of the display frames without changing a position of each of the display frames with respect to the display unit and information displayed in each of the display frames.

4. Aft non-transitory computer readable medium storing an information processing program for causing a computer to execute a method, comprising:
arranging at least two display frames on a screen, and displaying information in each display frame on a display unit;
detecting an orientation of the display unit; and
performing display, if it is detected in the detecting that top and bottom of the display unit have been exchanged, by exchanging top and bottom of display in each of the display frames without changing a position of each of the display frames with respect to the display unit and information displayed in each of the display frames.
